(19) United States
(12) Patent Application Publication
(10) Pub. No.: US 2018/0056565 A1
(43) Pub. Date: Mar. 1, 2018

(54) POST MOLD COOLING SYSTEM

(71) Applicant: Mold-Masters (2007) Limited, Georgetown (CA)

(72) Inventors: Richard SIERADZKI, Frankfort, IL (US); Bruce COXHEAD, Kleinburg (CA)

(21) Appl. No.: 15/558,036

(22) PCT Filed: Mar. 16, 2016
(86) PCT No.: PCT/US16/22662

§ 371 Date: Sep. 13, 2017

Related U.S. Application Data
(60) Provisional application No. 62/134,262, filed on Mar. 17, 2015.

(51) Int. Cl. B29C 45/72; B29C 35/16; B29C 45/17; B29C 45/42

(52) U.S. Cl. CPC B29C 45/7207; B29C 35/16; B29L 2031/712; B29C 45/42; B29C 2045/7214; B29C 45/1769

(57) ABSTRACT

A post mold cooling system for cooling preforms is disclosed. The post mold cooling system includes a take-out device that is configured to remove preforms from a molding area and deliver them to a post mold cooling area, and a cooling station that is configured to cool the preforms. A first transfer device is configured to transfer the preforms between the take-out device and the cooling station, and a second transfer device is configured to transfer the preforms away from the cooling station.

### CROSS-REFERENCE TO RELATED APPLICATIONS

The present application claims the benefit of U.S. Application No. 62/134,262, filed Mar. 17, 2015, which is incorporated by reference herein in its entirety.

### FIELD OF THE INVENTION

The present invention relates to injection molding, and more particularly to a post mold cooling system for newly molded article articles.

### BACKGROUND

In some injection molding applications, for example, the molding of preforms which are intermediate products that are subsequently processed to become a bottle or other container, newly molded articles are removed from the mold in which they are formed before they have fully cooled, and are cooled in a post mold cooling apparatus that is spaced apart from the mold.

### SUMMARY OF THE INVENTION

Embodiments hereof are directed to a post mold cooling system for cooling preforms. The post mold cooling system includes a take-out device that is configured to remove preforms from a molding area and deliver them to a post mold cooling area, and a cooling station that is configured to cool the preforms. A first transfer device is configured to transfer the preforms between the take-out device and the cooling station, and a second transfer device is configured to transfer the preforms away from the cooling station.

Embodiments hereof are directed to a post mold cooling system for cooling preforms, the post mold cooling system having a first post mold module and a second post mold module that is downstream from the first post mold module. The first post mold module has a take-out device and a first transfer device. The take-out device is translatable between a first configuration in which an end-of-arm-tool is positioned to receive a set of preforms from a mold, and a second configuration in which the end-of-arm-tool is aligned with the first transfer device. The first transfer device is translatable between a first configuration in which a first transfer tool is positioned to receive a set of preforms from the take-out device and a second configuration in which the first transfer tool is positioned to release a set of preforms to the second post mold module. The second post mold module has a cooling device positioned to receive a set of preforms from the first transfer device, and has a second transfer device translatable between a first configuration in which a second transfer tool is positioned to receive a set of preforms from the cooling device and a second configuration in which the second transfer tool is positioned to release a set of preforms at a location that is downstream from the cooling device.

Embodiments hereof are directed to a post mold cooling system for cooling a set of preforms. The post mold cooling system including a first frame portion and a second frame portion. The first frame portion having a take-out rail that extends in a direction that is perpendicular to a molding machine axis, and a first transfer rail that extends in a direction that is parallel to the molding machine axis. The second frame portion is positioned downstream from the first frame portion and has a cooling station and a second transfer rail that extends in a direction parallel to the first transfer rail. A take-out device coupled to the take-out rail and is translatable between a first configuration in which the take-out device is positioned to receive a set of preforms from a mold and a second configuration in which the take-out device is positioned to align with a first transfer device. The first transfer device coupled to the first transfer rail and translatable between a first configuration in which the first transfer device is positioned to receive a set of preforms from the take-out device and a second configuration in which the first transfer device is positioned to release a set of preforms to the cooling station. A second transfer device is coupled to the second transfer rail and is translatable between a first configuration in which the second transfer device is positioned to receive a set of preforms from the cooling station and a second configuration in which the second transfer device is positioned to release a set of preforms at a location that is downstream from the cooling station.

### BRIEF DESCRIPTION OF DRAWINGS

The foregoing and other features and advantages of the invention will be apparent from the following description of embodiments thereof as illustrated in the accompanying drawings. The accompanying drawings, which are incorporated herein and form a part of the specification, further serve to explain the principles of the invention and to enable a person skilled in the pertinent art to make and use the invention. The drawings are not to scale.

FIG. 1 is a perspective view of an injection molding cell having a post mold cooling system in accordance with an embodiment hereof that is suitable for use with an injection molding machine.

FIG. 2 is a perspective view of the post mold cooling system shown in FIG. 1.

FIG. 2A is an enlarged view of a portion of FIG. 2 showing a first transfer module of the post mold cooling system.

FIG. 2B is a perspective view of second and third transfer modules of the post mold cooling system.

FIG. 3 is a perspective view of the post mold cooling system at a first stage in an operational sequence thereof.

FIG. 4 is a perspective view of the post mold cooling system at a second stage in an operational sequence thereof.

FIG. 5 is a perspective view of the post mold cooling system at a third stage in an operational sequence thereof.

FIG. 6 is a perspective view of the post mold cooling system at a fourth stage in an operational sequence thereof.

FIG. 7 is a perspective view of the post mold cooling system at a fifth stage in an operational sequence thereof.

### DETAILED DESCRIPTION OF THE DRAWINGS

Specific embodiments of the present invention are now described with reference to the figures. The following detailed description is merely exemplary in nature and is not intended to limit the invention or the application and uses of the invention. In the following description, the term “downstream” is used with reference to the pathway travelled by a preform or a set of preforms as they are handled/conditioned, and is also used with reference to the order of components, or features thereof, which are used to handle/condition the preform or the set of preforms as they are moved along the pathway described above. The term “upstream” is used with reference to the opposite direction described above. Although the description of embodiments hereof is in the context of a preform injection molding system, the invention may also be used in other molding applications where it is deemed useful, nonlimiting examples of which include, compression molding or the like. Furthermore, there is no intention to be bound by any expressed or implied theory presented in the preceding technical field, background, brief summary or the following detailed description.

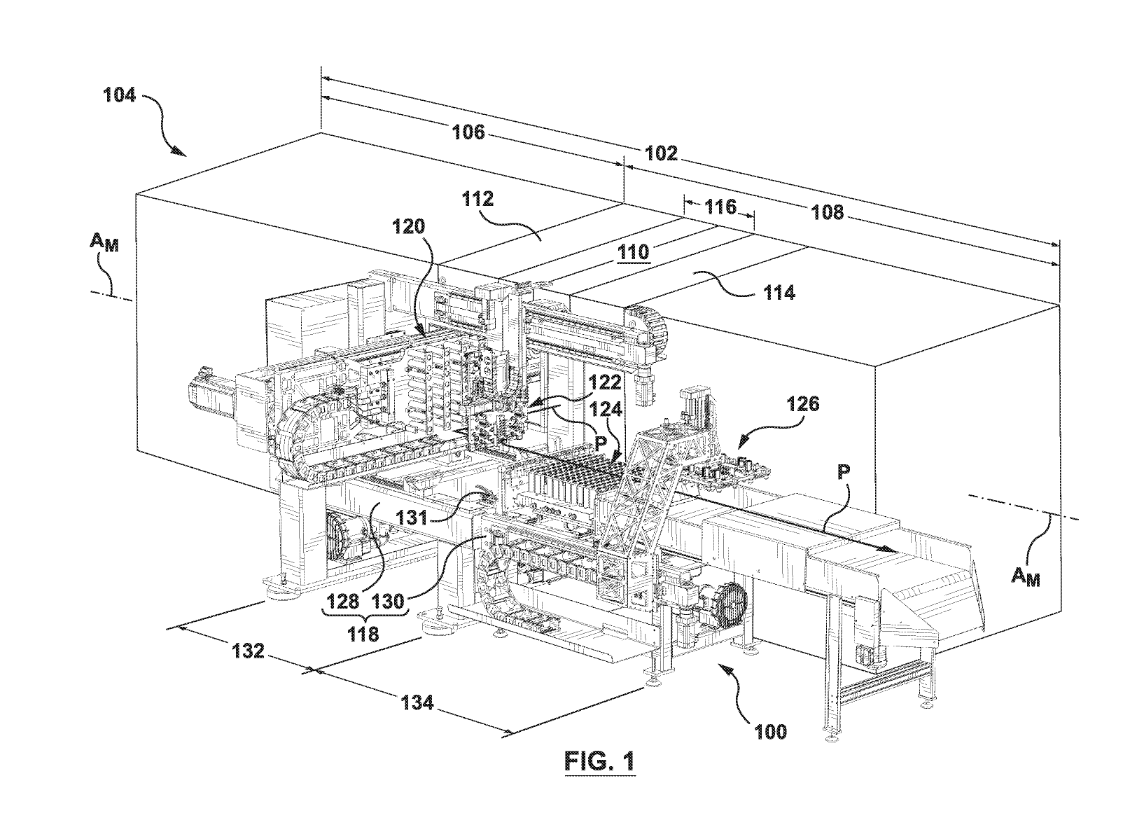

Referring now to FIG. 1, which is a perspective view of a post mold cooling system 100 in accordance with an embodiment hereof that is suitable for use with an injection molding machine 102 (shown as a schematic representation in FIG. 1). Together, post mold cooling system 100 and injection molding machine 102 make up a portion of an injection molding system or molding cell 104.

Injection molding machine 102 includes an injection assembly 106 and a clamping assembly 108 through which a horizontal machine axis A_{M} extends. Injection assembly 106 is configured to plasticize and inject molding material, for example, polyethylene terephthalate or PET into one or more cavities (not shown) within a mold 110 that is mounted between stationary and moving platens 112, 114 of clamping assembly 108. As disclosed herein by way of example and not limitation mold 110 has thirty two cavities that are shaped to mold a set of thirty two preforms, the cavities being arranged in an array having eight rows and four columns. Clamping assembly 108 is configured to horizontally move or translate moving platen 114 relative to stationary platen 112 between a closed configuration in which mold 110 is held shut by clamping assembly 108 to receive molding material from injection assembly 106, and an open configuration, in which mold 110 is separated by clamping assembly 108 to permit a set of newly molded preforms to be ejected/removed from mold 110 once the molding material that has been injected into the one or more cavities has sufficiently solidified. The space between stationary and moving platens 112, 114 may be referred to herein as the molding area 116.

Post mold cooling system 100 is configured to extract or receive preforms from mold 110 and cool them away from molding area 116 to a point where they can be handled without being damaged. The area occupied by the pathway P through which preforms are moved by post mold cooling system 100 can generally be referred to as the post mold cooling area, or the post mold handling area. Post mold cooling system 100 includes a support frame or frame 118, a take-out device 120, a first transfer device 122, a cooling station 124, and a second transfer device 126.

Frame 118 is positioned adjacent to clamping assembly 108 on the non-operator side of molding machine 102. Frame 118 serves as a structural foundation upon which take-out device 120, first transfer device 122, cooling station 124, and second transfer device 126 are mounted.

Frame 118 includes a first frame portion 128 and a second frame portion 130. First frame portion 128 serves as a structural base for take-out device 120 and first transfer device 122. Second frame portion 130 serves as a structural base for cooling station 124 and second transfer device 126. Second frame portion 130 is releasably coupled to first frame portion 128 by a coupling mechanism 131 extending therebetween. As shown in FIGS. 1, 2, 2A and 3-7 coupling mechanism 131 is for example, a toggle latch. Accordingly, post mold cooling system 100 can be considered to have a first post mold module 132, which includes first frame portion 128, take-out device 120, and first transfer device 122, and a separate second post mold module 134, which is releasably attached to first post mold module 132 and includes cooling station 124 and second transfer device 126. First post mold module 132 and second post mold module 134 are cooperative independent units that together create a more complex structure, i.e. post mold cooling system 100. This configuration allows second post mold module 134 to be readily separated from first post mold module 132, for example, to facilitate substituting second post mold module 134 with a differently configured second post mold module. Further, first and second post mold modules 132, 134 being created as separate post mold modules facilitates easier shipping of post mold cooling system 100 from a place of manufacture to a place of operation.

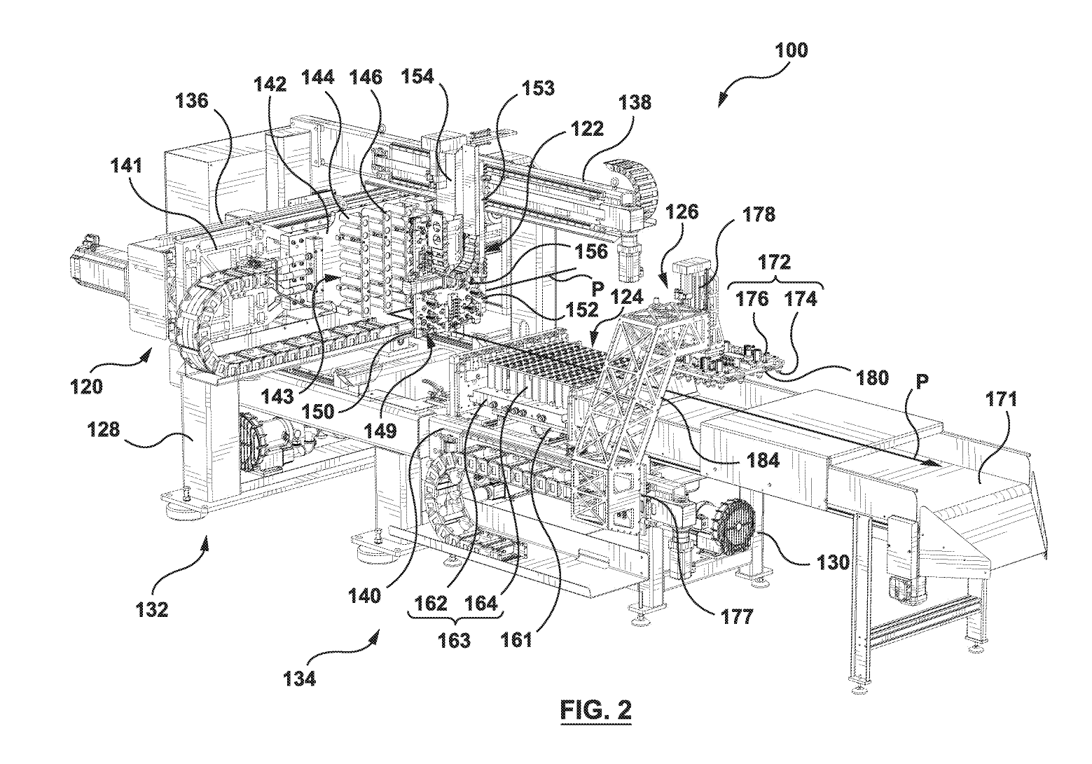

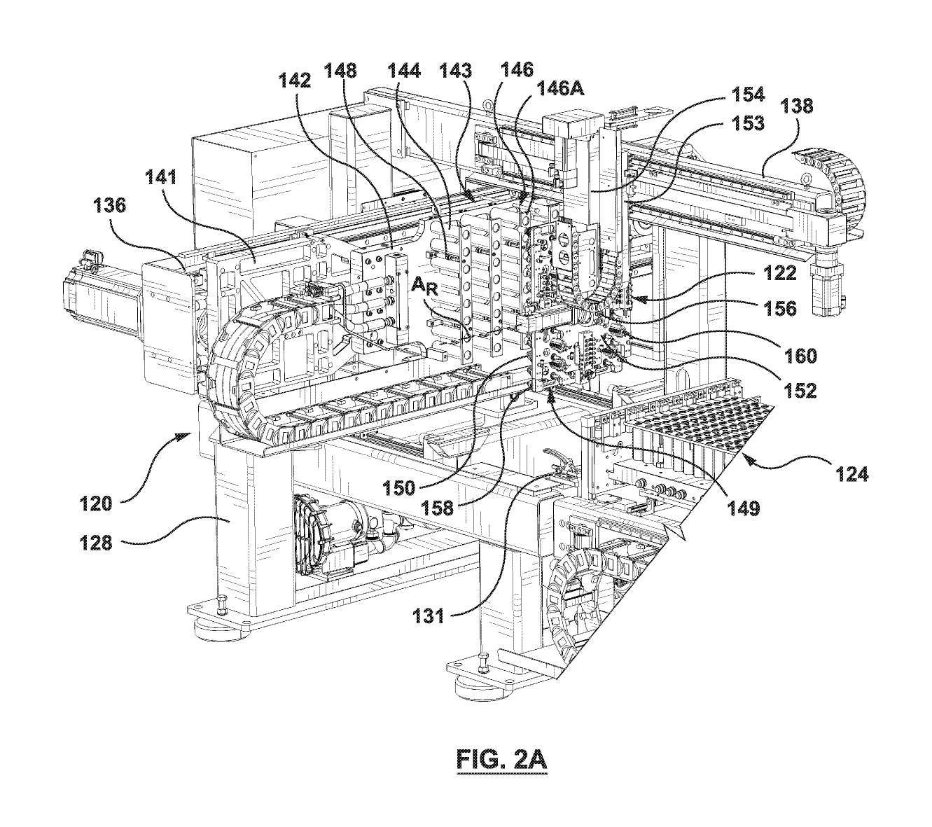

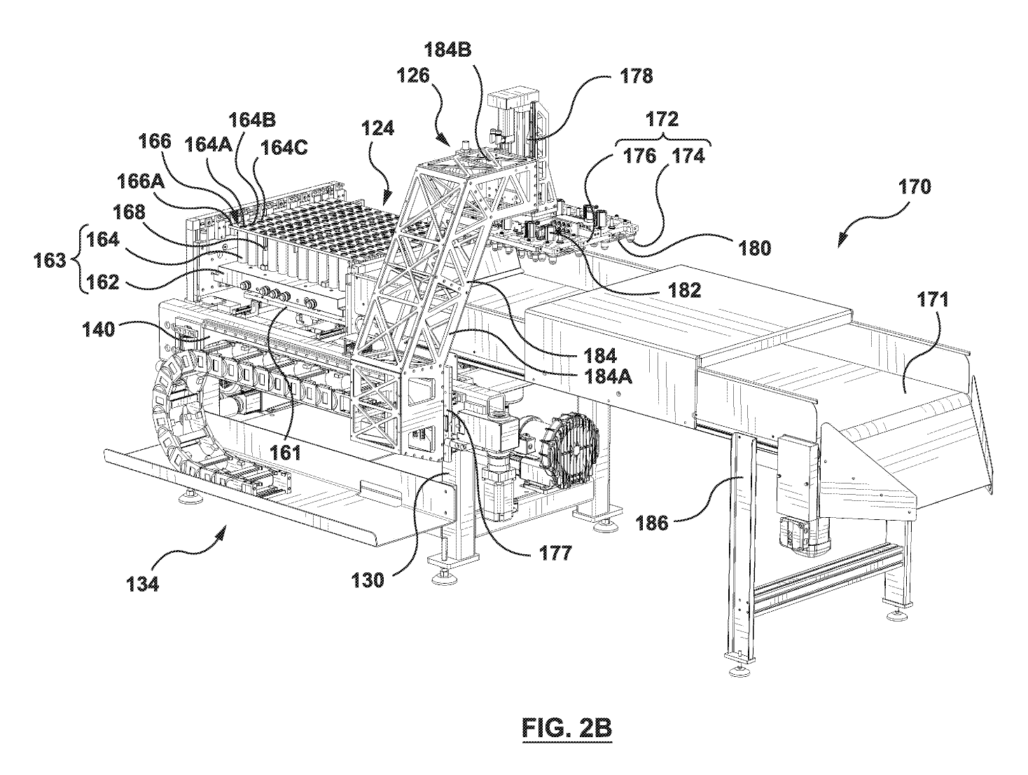

Referring now to FIG. 2 which is a perspective view of post mold cooling system 100 shown in FIG. 1. First frame portion 128 includes a take-out beam or rail 136 to which take-out device 120 is coupled, and a first transfer beam or rail 138 to which first transfer device 122 is coupled. First transfer rail 138, is positioned above take-out rail 136 and extends in a direction that is perpendicular thereto. Take-out rail 136 supports take-out device 120 and extends horizontally in a direction that is generally transverse or perpendicular to machine axis A_{M}. First transfer rail 138 supports first transfer device 122 and extends horizontally in a direction that is perpendicular to take-out rail 136, which is also generally parallel to machine axis A_{M}, to longitudinally overlap second frame portion 130. Second frame portion 130 includes a second transfer beam or rail 140 to which second transfer device 126 is coupled. Second transfer rail 140 extends horizontally in a direction that is generally parallel to machine axis A_{M}. Second transfer rail 140 is spaced apart from first transfer rail 138, and is positioned at a different elevation than first transfer rail 138. As shown in FIG. 2, first transfer rail 138 is positioned above the pathway P, whereas second transfer rail 140 is positioned below pathway P. Coupling first and second transfer devices 122, 126 to respective first and second transfer rails 138, 140, which are spaced apart from each other and are positioned on different sides of cooling station 124, permits rapid translation, independent movement, and overlapping positioning of first and second transfer devices 122, 126 as preforms are moved through post mold cooling system 100.

Continuing with FIG. 2 and also referring to FIG. 2A, which is an enlarged view of a portion of FIG. 2, take-out device 120 receives a set of newly molded preforms from mold 110 and moves the set of newly molded preforms away from molding machine 102 to a post mold cooling area. Take-out device 120 includes a take-out carriage 141 to which a replaceable end-of-arm-tool 143 (EOAT 143) having a first mounting plate 142 and a set of first receivers 144 is attached. The number of receivers in the set of first receivers 144 is equal to the number of cavities in mold 110, and the set of first receivers 144 is arranged in an array that corresponds to the array of the cavities defined by mold 110.

Take-out device 120 is configured as an initial stage of post mold cooling. Specifically the exterior surfaces of the body and end portions of each preform are cooled by way of conduction due to contact with first receivers 144 while they are held by EOAT 143. To accomplish this, EOAT 143 includes a network of fluid channels (not shown) that extend within first mounting plate 142 and each first receiver 144, though which a cooling fluid is circulated to maintain EOAT 143 at a suitable temperature to cool the set of preforms. EOAT 143 further includes a network of air channels (not shown) that also extend within first mounting plate 142 and first receivers 144. The air channels are in fluid communication between a source of pressurized air (not shown) and a receiving cavity inside of each receiver 144 to assist in transferring newly molded preforms between mold 110 and take-out device 120. Negatively pressurized air or suction holds the set of preforms in their respective first receiver 144 as EOAT 143 is moved away from mold 110. In the current embodiment, take-out device 120 optionally includes a take-out stripper 146, and respective stripper actuators 148, connected to the source of pressurized air, to assist with removing a set of preforms from first receivers 144 as they are being transferred between take-out device 120 and first transfer device 122. As shown in at least FIG. 2A, by way of example and not limitation, take-out stripper 146 is a plurality of plates 146A arranged in columns, each having a plurality of openings through which respective preforms pass as they are transferred to respective first receivers 144. When actuated, take-out stripper 146 bears on a support ring, or other finish portion, of each respective preform to separate or push the set of preforms from their respective first receiver 144 to ensure separation of a set of preforms from take-out device 120.

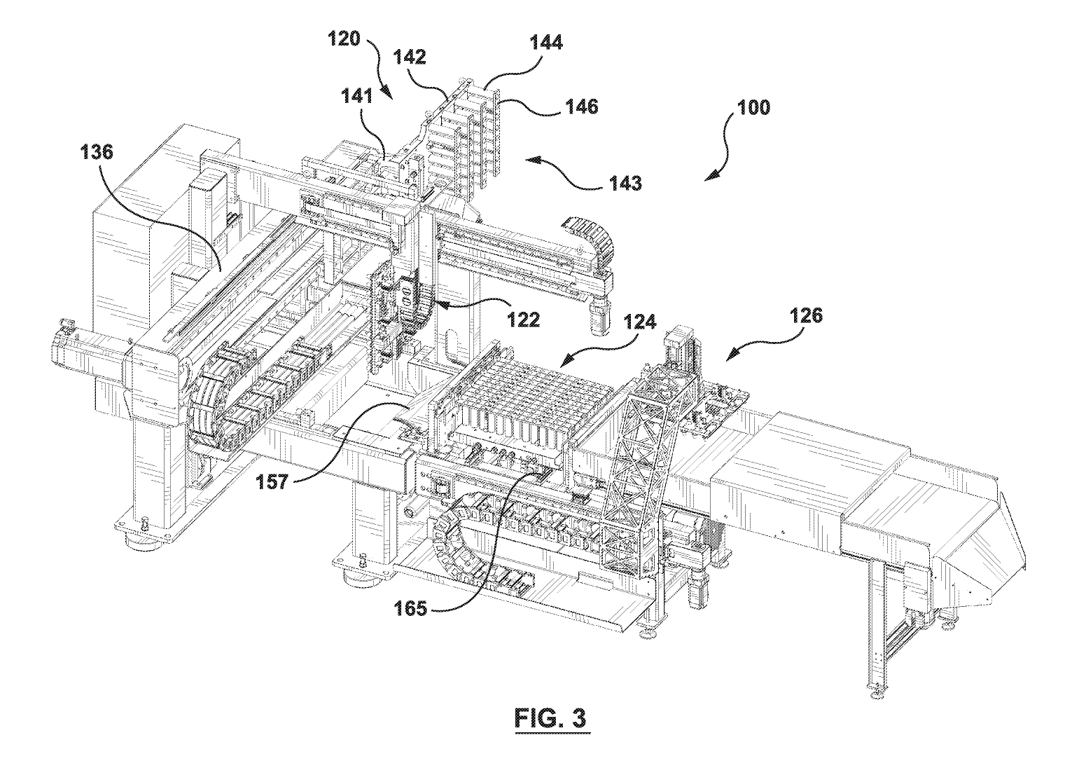

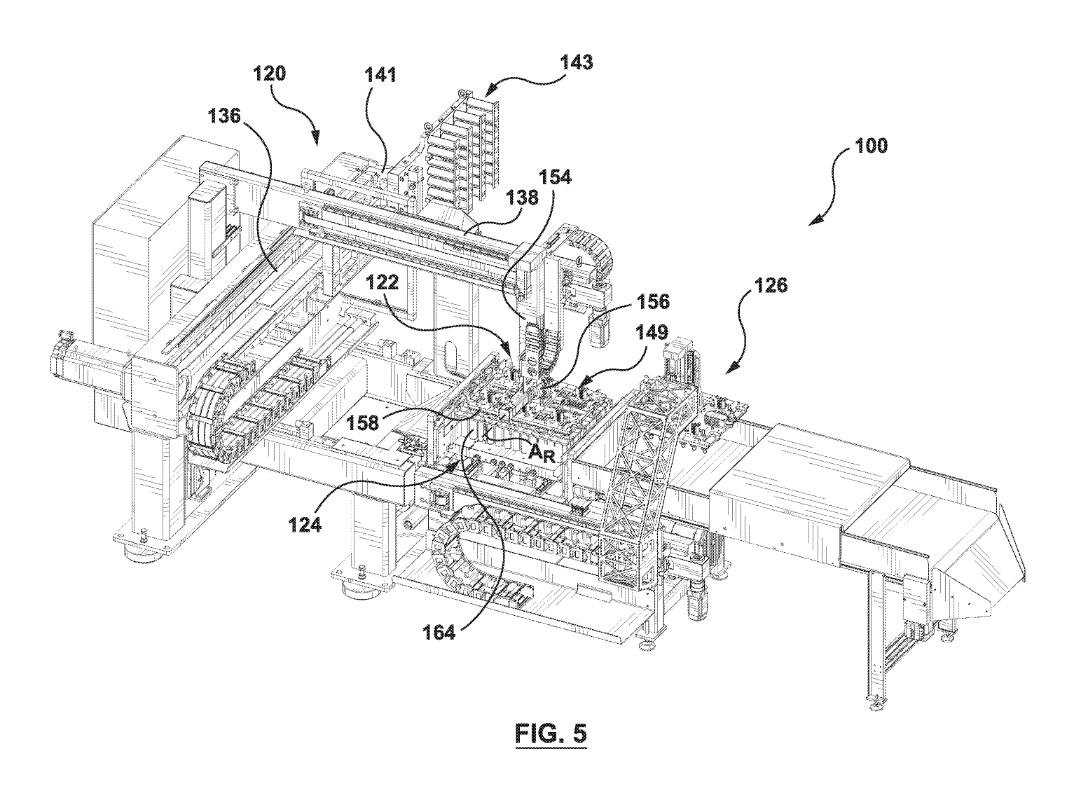

Take-out device 120 is mounted to take-out rail 136 via take-out carriage 141 and is configured to have one degree of freedom. Specifically, take-out carriage 141 is horizontally translatable along take-out rail 136 to move take-out device 120 between at least two positions or configurations. In a first or outbound position (shown in FIGS. 2 and 2A), in which the set of first receivers 144 are aligned with first transfer device 122, and a second or inbound position (shown in FIGS. 3 and 5), when mold 110 is opened by molding machine 102, and the set of first receivers 144 are aligned with respective mold cores (not shown) of mold 110 to receive a set of newly molded preforms therefrom. In an embodiment (not shown) take-out device 120 includes more than one set of first receivers. In such a configuration the take-out device 120 has more than one inbound position and more than one outbound position, as a set of preforms is held by EOAT 143 for a successive molding cycle before being transferred to first transfer device 122. Although not specifically called out, take-out device 120 can include a linear motion guide or linear bearing between take-out carriage 141 and take-out rail 136 so as to facilitate slidable movement therebetween.

First transfer device 122 moves a set of preforms between take-out device 120 and cooling station 124. First transfer device 122 includes a replaceable first transfer tool 149 having a set of first molded article pickers or first pickers 150 coupled to a first tooling plate 152. First transfer device 122 further includes a first transfer carriage 153, a first elevation actuator 154, and a rotary joint or rotational actuator 156. In the current embodiment first pickers 150 are provided in the form of mandrels that are sized to be inserted into the open end of a preform. Each first picker 150 has an opening extending therethrough (not shown) in fluid communication with the source of pressurized air. In operation, negative air pressure or suction applied to the interiors of the preforms via first pickers 150, in combination with movement of first transfer device 122 away from take-out device 120 extracts preforms from EOAT 143. Further, suction applied to the interior of the preforms via first pickers 150 holds the set of preforms to first transfer device 122 as they are moved between take-out device 120 and cooling station 124.

The number of pickers in the set of first pickers 150 is equal to the number of cavities in mold 110, and the set of first pickers 150 is arranged in an array that corresponds to the array of the cavities defined by mold 110. The specific pickers shown in the figures are by way of example and not limitation as other forms of molded article pickers are contemplated.

In the current embodiment, first transfer device 122 includes first transfer stripper 158 and respective actuators 160 that are coupled to first tooling plate 152 to assist with removing preforms from their respective picker 150 as they are deposited into cooling station 124. Similar to take-out stripper 146, by way of example and not limitation, first transfer stripper 158 is a plurality of plates arranged in an array, wherein each plate includes a plurality of openings through which a respective picker 150 projects. In operation, suction through the opening in each first picker 150 is applied to the interiors of the set of preforms to pull the set of preforms against first transfer stripper 158. The openings and pickers 150 are sized such that the suction pressure also causes air to circulate within the interiors of the set of preforms. When actuated, first transfer stripper 158 pushes against a top sealing surface, or other finish portion, of each respective preform to separate or push the set of preforms away from their respective picker 150 to ensure separation of a set of preforms from first transfer device 122.

First tooling plate 152 is coupled to first elevation actuator 154 via rotational actuator 156, and first elevation actuator 154 is coupled to first transfer rail 138 via first transfer carriage 153. According to this arrangement first transfer device 122 is suspended beneath, or hangs from, first transfer rail 138.

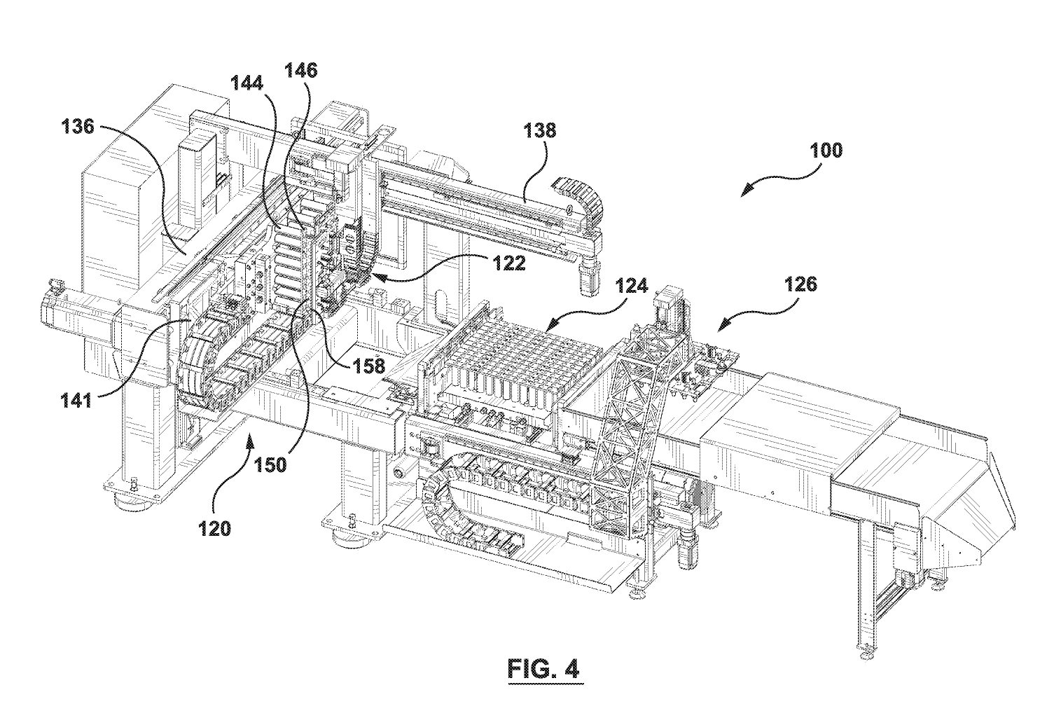

First transfer device 122 is mounted to first transfer rail 138 via first transfer carriage 153 and is configured to have three degrees of freedom. Specifically, first transfer carriage 153 is horizontally translatable along first transfer rail 138 to move first transfer device 122 between at least three horizontal positions: a first or inserted position (shown in FIG. 4) in which first transfer tool 149 is engagable with preforms held in take-out device 120, a second or retracted position (shown in FIG. 5) in which first transfer tool 149 is above cooling station 124, and a third intermediate or idle position (shown in FIGS. 2, 2A) that is between its first and second positions, in which first transfer tool 149 is, for example, ready to be advanced towards take-out device 120 once it has reached its outbound position.

Rotational actuator 156 is rotationally or angularly translatable about a horizontally extending rotary axis A_{R}, which is transverse to machine axis A_{M}, to move first transfer device 122 between at least two angular orientations: a first or extraction orientation (shown in FIGS. 2, 2A) in which first transfer tool 149 is vertically aligned and first pickers 144 are facing take-out device 120, and a second or insertion orientation (shown in FIG. 5) in which first transfer tool 149 is horizontally aligned and first pickers 150 are facing cooling station 124. In an embodiment (not shown) first transfer device 122 also has a third or ejection orientation, which is between its first and second orientations, in which first transfer device 122 can eject or release a set of preforms rather than deposit them into cooling station 124. A third angular orientation as such may be useful, for example, when it may not be necessary to move preforms throughout the entire post mold cooling process, examples of which include during set-up/testing of mold 110 and/or during set-up/testing of post mold cooling system 100. As visible in FIG. 3, first frame portion 128 includes a chute 157 upstream from second frame portion 130 for guiding the released preforms towards a suitable storage container (not shown).

Rotational actuator 156 is attached to first transfer tool 149 near a center point thereof such that an equal number of first pickers 150 are disposed on either side of the rotary axis A_{R}. According to this arrangement, as rotational actuator 156 moves first transfer tool 122 between its first and second orientations, the centrifugal force applied to preforms held by first pickers 150 on one side of rotary axis A_{R} is equal to or is substantially equal to the centrifugal force applied to preforms held by first pickers 150 on the other side of rotary axis A_{R}, which helps to reduce the likelihood of dropping preforms at the ends of first transfer tool 149 as it is moved between respective orientations.

First elevation actuator 154 is coupled to first transfer carriage 153 and is vertically translatable relative to first transfer rail 138 to move first transfer device 122 between at least two vertical positions or elevations: a first or take-out elevation (shown in FIGS. 2, 2A) in with first transfer tool 149 is raised or retracted to engage with preforms held in take-out device 120, and a second or deposit elevation (shown in FIG. 5) in which first transfer tool 149 is lowered or extended to deposit or release a set of preforms to cooling station 124.

Although not specifically called out, first transfer device 122 can include a linear motion guide or linear bearing between first transfer carriage 153 and first transfer rail 138 so as to facilitate slidable movement therebetween.

Continuing with FIG. 2 and also referring to FIG. 2B, which is a perspective view of second and third transfer modules of the post mold cooling system, cooling station 124 receives one or more set(s) of preforms from first transfer device 122. Cooling station 124 includes a cooling station carriage 161 to which a replaceable cooling device 163 is attached. Cooling device 163 includes a second mounting plate 162 and one or more sets of second receivers 164 attached thereto. In contrast to first receivers 144, which are arranged in a horizontal orientation, second receivers 164 are arranged in a vertical orientation. As shown herein, cooling station 124 includes three sets of second receivers 164A, 164B, 164C by way of example and not limitation, with the number of receivers in each set of second receivers 164A, 164B, 164C being equal to the number of cavities in mold 110, and with each set of second receivers 164A, 164B, 164C being arranged in an array that corresponds to the array of the cavities defined by the mold. In an alternative embodiment, cooling station 124 has other than three sets of receivers.

Cooling station 124 is configured as a second stage of post mold cooling. Specifically the exterior surfaces of the body and end portions of each preform are cooled by way of conduction due to contact with second receivers 164 while they are held by cooling device 163. To accomplish this, cooling device 163 includes a network of fluid channels (not shown) that extend within second mounting plate 162 and each second receiver 164, through which a cooling fluid is circulated to maintain cooling device 163 at a suitable temperature to cool the set(s) of preforms. Cooling device 163 further includes a network of air channels (not shown) that also extend within second mounting plate 162 and second receivers 164. The air channels are in fluid communication between the source of pressurized air and a receiving cavity inside of each second receiver 164 to assist in transferring preforms between first transfer device 122 and cooling station 124. Negatively pressurized air or suction pulls on each preform while it is held in its second receiver 164 to maintain contact therebetween as the size of each preform shrinks as it is cooled. In the current embodiment, cooling station 124 optionally includes a cooling station stripper 166, and respective stripper actuators 168, connected to the source of pressurized air, to assist with removing a set of preforms from their respective set of second receivers 164 as they are being transferred between cooling station 124 and second transfer device 126. As shown by way of example and not limitation, cooling station stripper 166 is a plurality plates 166A arranged in columns, each plate 166A having a plurality of openings through which respective preforms pass as they are transferred to respective second receivers 164. When actuated, cooling station stripper 166 bears on a support ring, or other finish portion, of each respective preform in a set of preforms to separate or push the set of preforms from their respective second receiver 164 to ensure separation of the set of preforms from cooling station 124.

As disclosed herein, by way of example and not limitation, second receivers associated with cooling station 124 are structurally and functionally similar to first receivers 144 associated with take-out device 120 so as to simplify the tooling requirements for post mold cooling system 100; however, in an alternative embodiment, second receivers 164 associated with cooling station 124 can be structurally and functionally different from first receivers 144 associated with take-out device 120.

Cooling station 124 is mounted to a cooling station rail 165 on second frame portion 130, and is configured to have one degree of freedom. Specifically, cooling station carriage 161 is horizontally translatable relative to the cooling station rail 165 on second frame portion 130 in a direction that is transverse to molding machine axis A_{M} in order to move cooling device 163 between a number of positions that is equal to the number of sets of second receivers 164. For example, in the current embodiment, cooling station 124 has three sets of second receivers 164A, 164B, 164C, accordingly cooling station 124 is translatable between a first receiving position, in which a first set of second receivers 164A are in line with first and second pickers 150, 174 on first and second transfer devices 122, 126, a second receiving position, in which a second set of second receivers 164B are in line with first and second pickers 150, 174 on first and second transfer devices 122, 126, and a third receiving position, in which a third set of second receivers 164C are in line with first and second pickers 150, 174 on first and second transfer devices 122, 126. Although not specifically called out, cooling station 124 can include a linear motion guide or linear bearing between cooling station carriage 161 and second frame portion 130 so as to facilitate slidable movement therebetween.

Second transfer device 126 moves a set of preforms away from cooling station 124 to a third post mold module 170, which in the current embodiment is a part handling device in the form of, for example, a conveyor 171. Second transfer device 126 includes a replaceable second transfer tool 172 having a set of second molded article pickers or second pickers 174, coupled to a second tooling plate 176. Second transfer device 126 further includes a second transfer carriage 177 and a second elevation actuator 178. In the current embodiment second pickers 174 are provided in the form of mandrels that are sized to be inserted into the open end of a preform. Each picker 174 has an opening extending therethrough (not shown) in fluid communication with a source of pressurized air. Negatively pressurized air or suction applied to the interior of the preforms via second pickers 174 in combination with movement of second transfer device 126 away from cooling station 124 extracts preforms from their respective cooling station holders. Further, suction applied to the interior of the preforms via pickers 174 holds preforms to second part transfer device 126 as they are moved between cooling station 124 and third post mold module 170.

The number of pickers in the set of second pickers 174 is equal to the number of cavities in mold 110; likewise, the set of second pickers 174 is arranged in an array that corresponds to the array of the cavities defined by mold 110. The specific pickers 174 shown are by way of example and not limitation as other forms of molded article pickers are contemplated.

In the current embodiment, second transfer device 126 includes a second transfer stripper 180 and respective actuators 182 coupled to second tooling plate 176 which assists with removing preforms from their respective second picker 174 as they are being released from second post mold module 134 to third post mold module 170. Similar to strippers 146, by way of example and not limitation, second transfer stripper 180 is a plurality of plates arranged in an array, with each plate having a plurality of openings through which a respective second picker 174 projects. In operation, suction through the opening in each second picker 174 is applied to the interiors of the set of preforms to pull the set of preforms against second transfer stripper 180. The openings and pickers 174 are sized such that the negatively pressurized air or suction pressure also causes air to circulate within the interiors of the set of preforms. When actuated, second transfer stripper 180 pushes against a top sealing surface, or other finish portion, of each respective preform to separate or push the set of preforms away from their respective picker 174 to ensure separation of a set or preforms from second transfer device 126.

Second tooling plate 176 is coupled to second elevation actuator 178 which is coupled to an upper end of an elevation beam or arm member 184 that extends from second transfer carriage 177. Second elevation actuator 178 is attached to second tooling plate 175 near to the center point thereof such that an equal number of the set of second pickers 174 are disposed on the upstream side of second elevation actuator 178 as are disposed on the downstream side of second elevation actuator 178. Arm member 184 is a truss-like assembly that has an inverted generally L-shape that extends upward from second transfer rail 140 and over top of second frame portion 130. Arm member 184 has a vertically extending arm portion 184A that is coupled to second transfer carriage 177 and a horizontally extending arm portion 184B that is coupled to second elevation actuator 178 such that second transfer tool 172 is suspended above second frame portion 130. As shown, vertically extending arm portion 184A extends upward at an angle, which shortens required length of horizontally extending arm portion 184B.

As disclosed herein, by way of example and not limitation, second transfer tool 172 is structurally and functionally similar to first transfer tool 149 associated with first transfer device 122; however in an alternative embodiment, second transfer tool 172 can be structurally and functionally different from first transfer tool 149. For example, to assist with cooling the interiors of a set of preforms, positively pressurized air can be applied to the interior surfaces of the set of preforms via first pickers 150 associated with first transfer tool 149 at times when suction is not required to extract or hold the set of preforms, for example, as first transfer device 122 is advanced towards take-out device 120 and first pickers 150 are inserted into a set of preforms in the set of first receivers 144.

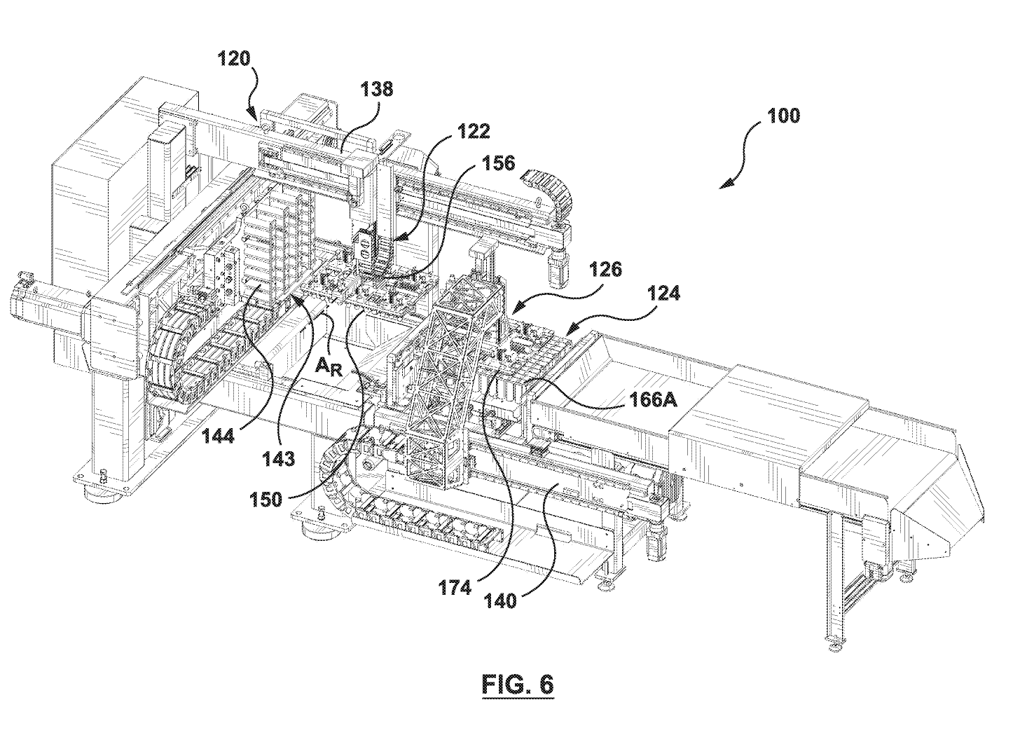

Second transfer device 126 is mounted to second transfer rail 140 and is configured to have two degrees of freedom. Specifically, second transfer carriage 177 is horizontally translatable along second transfer rail 140 to move second transfer device 126 between at least two horizontal positions: a first or cooling station position (shown in FIG. 6) in which second transfer tool 172 is aligned with cooling station 124, and a second or deposit position (shown in FIG. 2), in which second transfer tool 172 is located downstream from cooling station 124 to be aligned with third post mold module 170 for transferring a set of preforms thereto.

Second elevation actuator 178 is vertically translatable relative to second transfer rail 140 to move second transfer device 126 between at least two vertical positions or elevations: a first or extraction elevation (shown in FIG. 6) in which second transfer device 126 is lowered or positioned to engage with a set of preforms held in a set of second receivers 164 in cooling station 124, and a second or clearance elevation (shown in FIGS. 2, 2A) in which second transfer device 126 is raised or positioned relative to cooling station 124 such that a set of preforms are fully removed from a set of second receivers 164, and can be horizontally translated towards third post mold module 170.

In an embodiment (not shown) second transfer device 126 has another vertical position or elevation, for example, a third intermediate elevation in which second elevation actuator 178 has positioned second transfer tool 172 in between its clearance and extraction elevations in order to reduce the vertical distance that a set of preforms fall as they are transferred to conveyor 171, or other third post mold module 170.

Although not specifically called out, second transfer device 126 can include a linear motion guide or linear bearing between second transfer carriage 177 and second transfer rail 140 so as to facilitate slidable movement therebetween.

As mentioned above, third post mold module 170 is provided in the form of a conveyor 171. Third post mold module 170 includes a third frame portion 186 which is overlapped by second transfer rail 140. Third frame portion 186 serves as a structural base for conveyor 171. As shown herein conveyor 171 is an endless belt conveyor which receives cooled preforms from second transfer device 126 and transports them away from the post mold cooling area to a suitable storage container (not shown), for example, a pallet box.

Third frame portion 186 is releasably coupled to second frame portion 130 by a coupling mechanism extending therebetween, which is not shown but can include, for example, a toggle latch extending between second frame portion 130 and third frame portion 186. This configuration allows third post mold module 170 to be readily separated from second post mold module 134, for example, to facilitate substituting third post mold module 170 with differently configured third post mold module. An example of a differently configured third post mold module may be a different part handling, sorting, or storage device, for example, a so-called “soft-drop” container.

An operational sequence of post mold cooling system 100 will now be described with reference to FIGS. 3 to 7.

FIG. 3 is a perspective view of post mold cooling system 100 at a first stage in an operational sequence thereof. An injection molding machine, for example, injection molding machine 102 has opened a mold, for example mold 110, at the end of a first injection cycle and take-out device 120 has been translated to its second configuration in which first receivers 144 are in line with the cores of the opened mold to receive a first set of newly molded preforms (not shown). Ejection action by the mold in combination with suction in the set of first receivers 144 moves the first set of newly molded preforms from the mold to take-out device 120. First transfer device 122 is in its third or intermediate position, second transfer device 126 is in its second or deposit position, and cooling station 124 is in its first receiving position.

FIG. 4 is a perspective view of post mold cooling system 100 at a second stage in an operational sequence thereof. Take-out device 120 has been translated to its first configuration in line with first transfer device 122, and first transfer device 122 has been translated from its intermediate configuration to its first configuration in which first pickers 150 are positioned to extract the first set of preforms from the set of first receivers 144. Suction in first receivers 144 can be halted and take-out stripper 146 actuated to push the first set of preforms towards first transfer device 122. Concurrently, suction is applied to the insides of the set of preforms via first pickers 150 to pull the top sealing surfaces of the first set of preforms against first transfer stripper 158 to assist with moving the first set of preforms from take-out device 120 to first transfer device 122.

FIG. 5 is a perspective view of post mold cooling system 100 at a third stage in an operational sequence thereof. Take-out device 120 has been translated back to its second configuration to receive a second set of newly molded preforms (not shown) from a mold that has been opened by a molding machine. Cooling station 124 is still in its first receiving position, and first transfer device 122 has been horizontally translated to its second or retracted position, rotated to its second or insertion orientation, and vertically translated to its second or deposit elevation such that the first set of preforms can be transferred to the first set of second receivers 164A. Suction pressure used to hold the first set of preforms can be halted, and first transfer stripper 158 is actuated to deposit the first set of preforms from first transfer device 122 into the first set of second receivers 164A. Suction is used to pull the first set of preforms into contact with second receivers 164A. After the first set of preforms has been transferred to cooling station 124, first transfer device 122 is vertically translated to its first or take-out elevation, rotated to its first or extraction orientation, and horizontally translated to its third or intermediate configuration where it waits until take-out device 120 has received a next set of preforms and moved to its first position.

The preceding operational stages are repeated two additional times, such that take-out device 120 and first transfer device 122 respectively transfer second and third sets of preforms from the mold to respective second and third sets of second receivers 164B, 164C. Accordingly, prior to receiving the second set of preforms, cooling station 124 is translated to its second receiving position such that first transfer device 122 deposits the second set of preforms into second set of second receivers 164B, and prior to receiving the third set of preforms, cooling station 124 is translated to its third receiving position such that first transfer device 122 deposits the third set of preforms into third set of second receivers 164C.

FIG. 6 is a perspective view of post mold cooling system 100 at a fourth stage in an operational sequence thereof. Take-out device 120 is in its first or outbound position, first transfer device 122 has been translated to its third or intermediate configuration and rotated to its second or insertion orientation after having extracted a fourth set of preform from first receivers 144 which were previously extracted from the mold by take-out device 120. Suction pressure used to hold the fourth set of preforms with first transfer device 122. Second transfer device 126 is has been horizontally translated to its cooling station position, and vertically translated to its extraction elevation such that second pickers 174 are inserted into the open ends of the first set of preforms. At this point cooling station stripper 166 can be actuated to push the first set of preforms from the first set of second receivers 164 towards the set of second pickers 174. Suction pressure is applied to the insides of the first set of preforms via second pickers 174 to help move the first set of preforms from cooling station 124 to second transfer device 126, and to hold the first set of preforms with second transfer device 126 as it is moved to its clearance elevation and its deposit position.

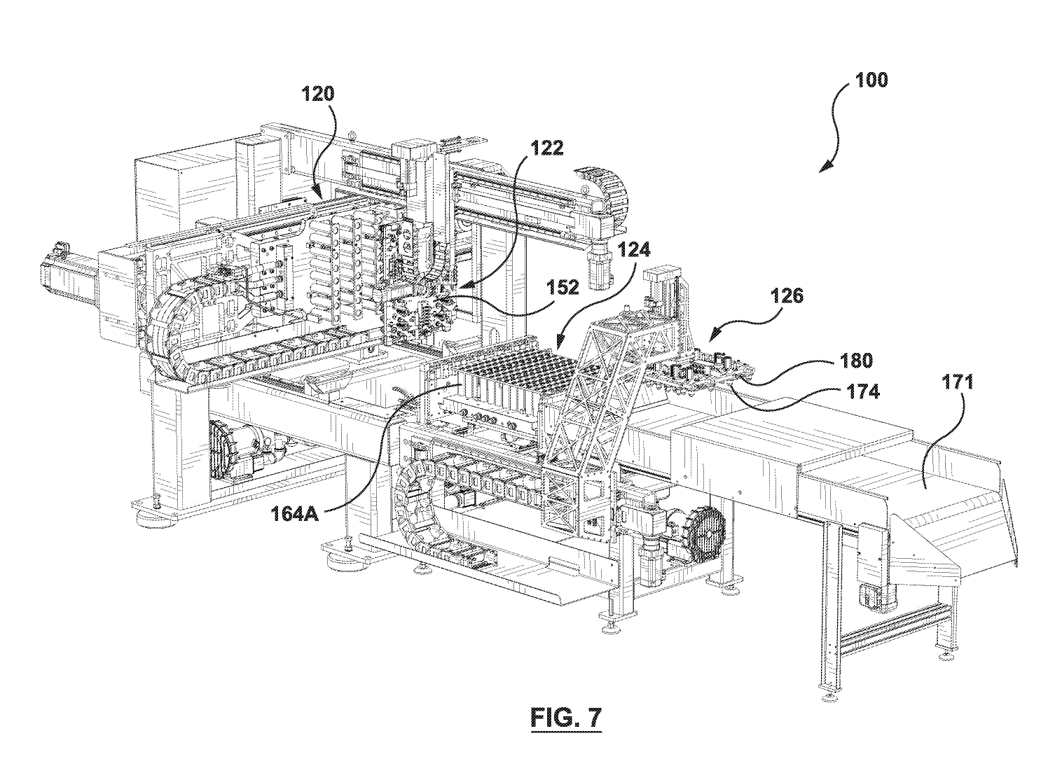

FIG. 7 is a perspective view of post mold cooling system 100 at a fifth stage in an operational sequence thereof After having deposited the fourth set of preforms into the first set of second receivers 164A, first transfer device 122 has been vertically translated to its take-out elevation, horizontally translated to its idle position, and rotated such that first tooling plate 152 is in its extraction orientation, and ready to be advanced towards take-out device 120 to extract a fifth set of preforms therefrom, once take-out device 120 is in its outbound position. Second transfer device 126 has been vertically translated to its clearance elevation, and horizontally translated to its deposit position. Suction pressure, in combination with relative vertical movement between second transfer device 126 and cooling station 124, removed the first set of preforms from their respective second receivers 164. Once in its deposit position, suction can be halted, and second transfer stripper 180 actuated to release or deposit the first set of preforms onto the conveyor 170 to be moved away from the post mold cooling area.

With each subsequent molding cycle, second transfer device 126 moves a subsequent set of cooled preforms from a subsequent set of second receivers 164 to conveyor 170, and first transfer device 122 moves a subsequent set of newly molded preforms from take-out plate 120 to the newly vacated set of second receivers 164.

Although not specifically described herein, it should be appreciated that first, second, and third post mold modules 132, 134, 170 include respective drive apparatus (for example, motors, encoders, belts etc.) connected to a controller for coordinating and translating take-out device 120, first transfer device 122, cooling station 124, and second transfer device 126 between their respective positions.

End-of-arm-tool 143, cooling device 163, and first and second transfer tools 149, 172 can collectively or individually be referred to as post mold tooling. Post mold tooling is typically paired with a specific mold, for example mold 110, and is configured to handle a set of preforms made in that specific mold. Accordingly, when a first mold is removed from a molding machine and is replaced with a different mold, the first post mold tooling is removed from post mold cooling system 100 and is replaced with different post mold tooling which is configured to handle a set of preforms made in the different mold. That is, in the preceding description mold 110 is described as having thirty two cavities, and post mold cooling system 100 is likewise described having post mold tooling that is configured to handle sets of thirty two preforms that are received from mold 110; however, it should be understood that mold 110 could have other than thirty two cavities, and that post mold cooling system would likewise be equipped with post mold tooling that is configured to handle sets of other than thirty two preforms.

In some instances, for example, where only a so-called “A” side of a mold is replaced with a different “A” side of the mold, it may only be necessary to replace the EOAT and the cooling device, with a different EOAT and cooling device, and to continue operating with the same first and second transfer tools. In other instances, for example, where only a so-called “B” side of a mold is replaced with a different “B” side of the mold, it may only be necessary to replace the first and second transfer tools with different first and second transfer tools, and to continue operating with the same EOAT and the cooling device.

While various embodiments have been described above, it should be understood that they have been presented only as illustrations and examples of the present invention, and not by way of limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the appended claims and their equivalents. It will also be understood that each feature of each embodiment discussed herein, and of each reference cited herein, can be used in combination with the features of any other embodiment. All patents and publications discussed herein are incorporated by reference herein in their entirety.

1. A post mold cooling system for cooling a set of preforms, the post mold cooling system comprising:
a first post mold module and a second post mold module, the second post mold module positioned downstream from the first post mold module,
the first post mold module including a take-out device having an end-of-arm-tool, and a first transfer device having a first transfer tool, the take-out device translatable between a first configuration in which the end-of-arm-tool is positioned to receive the set of preforms from a mold and a second configuration in which the end-of-arm-tool is aligned with the first transfer device, and the first transfer device translatable between a first configuration in which the first transfer tool is positioned to receive the set of preforms from the take-out device and a second configuration in which the first transfer tool is positioned to release the set of preforms to the second post mold module, and
the second post mold module including a cooling station having a cooling device, and a second transfer device having a second transfer tool, the cooling device positioned to receive the set of preforms from the first transfer device, and the second transfer device translatable between a first configuration in which the second transfer tool is positioned to receive the set of preforms from the cooling device and a second configuration in which the second transfer tool is positioned to release the set of preforms at a location that is downstream from the cooling device.

2. The post mold cooling system of claim 1, wherein the first post mold module includes a first frame portion having a take-out rail that extends in a direction perpendicular to a molding machine axis, and to which the take-out device is coupled and wherein the end-of-arm-tool is coupled to the take-out rail via a take-out carriage, the take-out carriage translatable along the take-out rail to move the end-of-arm-tool between at least two horizontal positions.

3. (canceled)

4. The post mold cooling system of claim 2, wherein the first frame portion includes a first transfer rail that extends in a direction parallel to the molding machine axis and to which the first transfer device is coupled and wherein the first transfer device is coupled to the first transfer rail via a first transfer carriage, the first transfer carriage translatable along the first transfer rail to move the first transfer device between at least two horizontal positions.

5. (canceled)

6. The post mold cooling system of claim 4, wherein the first transfer device includes a first elevation actuator coupled to the first transfer carriage, the first elevation actuator for moving the first transfer tool between at least two vertical elevations and .

[symbol]

7. The post mold cooling system of claim 6, wherein the first transfer device includes a rotary actuator coupled between the first elevation actuator and the first transfer tool, the rotary actuator for moving the first transfer tool between at least two angular orientations and wherein the first transfer tool has a plurality of first pickers arranged in an array and the rotary actuator is coupled to the first transfer tool such that an equal number of pickers are disposed on either side of a rotary axis extending through the rotary actuator.

8. (canceled)

9. The post mold cooling system of claim 1, wherein the second post mold module includes a second frame portion having a cooling station rail that extends in a direction perpendicular to a molding machine axis, and to which the cooling device is coupled and wherein the cooling device is coupled to the cooling station rail via a cooling device carriage, the cooling device having at least one set of cooling station receivers, the cooling device carriage for moving the cooling device between a number of positions equal to a number of sets of cooling station receivers.

10. (canceled)

11. The post mold cooling system of claim 1, wherein the second post mold module includes a second frame portion having a second transfer rail that extends in a direction parallel to a molding machine axis, and to which the second transfer device is coupled and wherein the second transfer device is coupled to the second transfer rail via a second transfer carriage, the second transfer carriage translatable along the second transfer rail to move the second transfer device between at least two horizontal positions.

12. (canceled)

13. The post mold cooling system of claim 11, wherein the second transfer device includes an arm member extending between the second transfer carriage and the second tool and wherein the second transfer device includes a second elevation actuator coupled to an upper end of the arm member, the second elevation actuator for moving the second transfer tool between at least two vertical elevations.

14. (canceled)

15. (canceled)

16. The post mold cooling system of claim 13, wherein the second transfer tool has a plurality of second pickers arranged in an array, and the second elevation actuator is coupled to the second transfer tool such that an equal number of pickers are disposed on either side of the second elevation actuator.

17. The post mold cooling system of claim 1, wherein the end-of-arm-tool includes a mounting plate and a set of horizontally arranged receivers, each horizontally arranged receiver having an internal cooling channel and a cavity sized to receive a preform, and wherein the cooling device includes a mounting plate and at least one set of vertically arranged receivers, each vertically arranged receiver having an internal cooling channel and a cavity sized to receive a preform.

18. The post mold cooling system of claim 1, wherein the first transfer tool includes a base plate and a set of mandrels sized to be inserted into an open end of a preform, and each mandrel having an opening extending therethrough in fluid communication with a source of pressurized air, and wherein the second transfer tool includes a base plate and a set of mandrels sized to be inserted into an open end of a preform, and each mandrel having an opening extending therethrough in fluid communication with a source of pressurized air.

19-20. (canceled)

21. The post mold cooling system of claim 1, wherein the first transfer device is translatable to a third configuration in which the first transfer tool is positioned to release a set to preforms upstream of the second post mold module.

22. The post mold cooling system of claim 1, further comprising:
a third post mold module disposed downstream from the second post mold module wherein the third post mold module is a part handling device.

23. (canceled)

24. A post mold cooling system for cooling a set of preforms, the post mold cooling system comprising:
a first frame portion having a take-out rail that extends in a direction perpendicular to a molding machine axis, and a first transfer rail that extends in a direction parallel to the molding machine axis; and
a second frame portion positioned downstream from the first frame portion and having a cooling station and a second transfer rail that extends in a direction parallel to the first transfer rail; and
a take-out device coupled to the take-out rail and translatable between a first configuration in which the take-out device is positioned to receive a set of preforms from a mold and a second configuration in which the take-out device is positioned to align with a first transfer device,
the first transfer device coupled to the first transfer rail and translatable between a first configuration in which the first transfer device is positioned to receive the set of preforms from the take-out device and a second configuration in which the first transfer device is positioned to release the set of preforms to the cooling station; and
a second transfer device coupled to the second transfer rail and translatable between a first configuration in which the second transfer device is positioned to receive the set of preforms from the cooling station and a second configuration in which the second transfer device is positioned to release the set of preforms at a location that is downstream from the cooling station.

25. The post mold cooling system of claim 24, wherein the second frame portion is releasably coupled to the first frame portion.

26. The post mold cooling system of claim 24, wherein the first transfer rail longitudinally overlaps with the cooling station.

27. The post mold cooling system of claim 24, wherein the first transfer rail and the second transfer rail are positioned at different elevations.

28. The post mold cooling system of claim 24, wherein the first transfer rail is positioned above a pathway along which sets of preforms pass as they are handled by the post mold cooling system, and the second transfer rail is positioned below the pathway.

29. The post mold cooling system of claim 24, wherein the first frame portion further comprises a chute upstream from the second frame portion.

30. The post mold cooling system of claim 24, further comprising:
a third frame portion positioned downstream from the second frame portion.
